(19) United States
(12) Patent Application Publication
(10) Pub. No.: US 2019/0149490 A1
(43) Pub. Date: May 16, 2019

(54) INFORMATION PROCESSING APPARATUS AND NON-TRANSITORY COMPUTER READABLE MEDIUM

(71) Applicant: FUJI XEROX CO.,LTD., Tokyo (JP)

(72) Inventor: Kengo TOKUCHI, Kanagawa (JP)

(73) Assignee: FUJI XEROX CO.,LTD., Tokyo (JP)

(21) Appl. No.: 15/996,532

(22) Filed: Jun. 4, 2018

(30) Foreign Application Priority Data
Nov. 14, 2017 (JP) 2017-219319
Jan. 5, 2018 (JP) 2018-000709

(51) Int. Cl. H04L 12/58; G10L 13/04; G10L 15/22

(52) U.S. Cl. CPC H04L 51/02; H04L 51/04; G10L 2015/223; G10L 13/043; G10L 15/22; H04L 51/24

(57) ABSTRACT

An information processing apparatus includes a changing unit that changes a determination criterion for a response from a response assistant that responds to an inquiry of a user. In a further modification of the invention, the determination criterion may include a plurality of setting items, and the changing unit may change the contents of the setting items each individually.

### CROSS-REFERENCE TO RELATED APPLICATIONS

This application is based on and claims priority under 35 USC 119 from Japanese Patent Application No. 2017-219319 filed Nov. 14, 2017 and Japanese Patent Application No. 2018-000709 filed Jan. 5, 2018.

### BACKGROUND

### Technical Field

The present invention relates to an information processing apparatus and a non-transitory computer readable medium.

### SUMMARY

According to an aspect of the invention, an information processing apparatus includes a changing unit that changes a determination criterion for a response from a response assistant that responds to an inquiry of a user.

### BRIEF DESCRIPTION OF THE DRAWINGS

Exemplary embodiments of the present invention will be described in detail based on the following figures, wherein:

FIG. 1 is a block diagram illustrating the configuration of an information processing system according to a first exemplary embodiment of the present invention;

FIG. 2 is a block diagram illustrating the configuration of a terminal device;

FIG. 3 is a view for explaining setting items;

FIG. 4 is a view illustrating a screen for setting a determination criterion;

FIG. 5 is a view illustrating a screen for interacting with a response assistant;

FIG. 6 is a view illustrating a screen for interacting with a response assistant;

FIG. 7 is a view for explaining how to generate a sound;

FIG. 8 is a view illustrating a screen for interacting with a response assistant;

FIG. 9 is a block diagram illustrating the configuration of an information processing system according to a third exemplary embodiment;

FIG. 10 is a perspective view illustrating a repeater;

FIG. 11 is a block diagram illustrating the configuration of the repeater;

FIG. 12 is a view for explaining how to emit light from a light emitting unit;

FIG. 13 is a view for explaining an image of a speaker;

FIG. 14 is a view illustrating an image of a speaker; and

FIG. 15 is a view illustrating an image of a speaker.

### DETAILED DESCRIPTION

### First Exemplary Embodiment

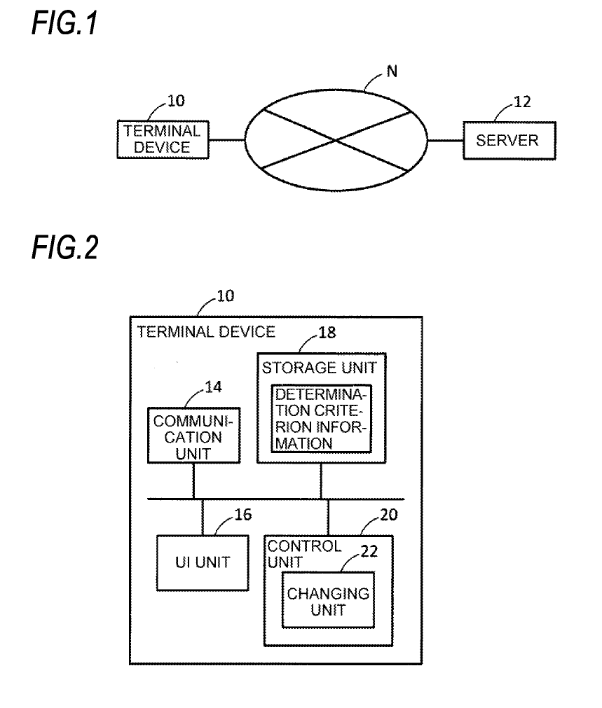

Hereinafter, an information processing system according to a first exemplary embodiment of the present invention will be described with reference to FIG. 1. FIG. 1 illustrates an example of the information processing system according to the first exemplary embodiment.

The information processing system according to the first exemplary embodiment includes a terminal device 10 and a server 12 as an example. For example, the terminal device 10 and the server 12 each have a function of communicating with other devices via a communication path N such as the Internet. Of course, the terminal device 10 and the server 12 may communicate with other devices via different communication paths or may directly communicate with other devices without using the communication path N. It is to be noted that plural terminal devices 10 and plural servers 12 may be included in the information processing system.

The terminal device 10 is, for example, a device such as a personal computer (PC), a tablet PC, a smartphone or a mobile phone and has a function of exchanging data with other devices. The terminal device 10 may be a wearable terminal (e.g., a wristwatch type terminal, a wristband type terminal, a spectacle type terminal, a ring type terminal, a contact lens type terminal, an intracorporeal embedded terminal, a hearable terminal, etc.). Further, the terminal device 10 may have a flexible display as a display device, such as an organic electroluminescence type display (flexible organic EL display), an electronic paper type display, a flexible liquid crystal display or the like, or flexible displays employing other display modes. The flexible display is a display with a flexibly-deformable display portion which can be, for example, bent, folded, rolled, twisted, or stretched. The terminal device 10 may be entirely composed of a flexible display or may be composed of a flexible display and other components which are functionally or physically separated from each other.

The server 12 is a device for managing data and user information. Further, the server 12 has a function of exchanging data with other devices. The server 12 may offer a social networking service (SNS) to a user. In this case, the terminal device 10 may use the SNS offered by the server 12 to exchange information (e.g., a character string, a still image, a moving image, a voice, etc.) with another terminal device 10 using the SNS.

In the first exemplary embodiment, a communication partner having a function of communicating with a user is used in the terminal device 10. The communication partner functions as a response assistant that responds to an inquiry of the user. For example, the communication partner receives a remark of the user, analyzes the contents of the remark, creates a response such as an answer to the remark and notifies the response to the user. For example, the user's remark is made by character input, voice input, image input or the like and the response is made by character output, voice output, image output or the like. The communication partner is implemented, for example, by executing a program which is, for example, installed in the terminal device 10. Of course, the program related to the communication partner may be installed in an external device such as the server 12, and the function of the communication partner or a service offering the function may be offered to the terminal device 10 from the external device such as the server 12.

The above-mentioned communication partner includes, for example, an automatic response AI implemented by artificial intelligence (AI). The automatic response AI has a function of analyzing the content of the user's remark and notifying the user of a response such as an answer to the contents of the remark. The automatic response AI may be a so-called chatbot (an automatic chatting program utilizing artificial intelligence). The automatic response AI may have an artificial intelligent learning function having the ability to make a determination close to human determination. In addition, the automatic response AI may adopt neural network type deep learning, reinforcement learning which partially reinforces a learning field, a genetic algorithm, cluster analysis, a self-organization map, ensemble learning, or other artificial intelligence-related techniques. Of course, artificial intelligence-related techniques other than the above may also be used. The automatic response AI may use a network such as the Internet to search an answer to a user's inquiry, create a response based on a result of the search and notify the response to the user.

Hereinafter, the configuration of the terminal device 10 will be described in detail with reference to FIG. 2.

A communication unit 14 is a communication interface and has a function of transmitting data to other devices and a function of receiving data from other devices. The communication unit 14 may be either a communication interface having a wireless communication function or a communication interface having a wired communication function. For example, the communication unit 14 corresponds to one or more types of communication methods and may communicate with a communication partner according to a communication method suitable for the communication partner (i.e., a communication method supported by the communication partner). The communication method is, for example, infrared communication, visible light communication, Wi-Fi® communication, close proximity wireless communication (e.g., NFC (Near Field Communication), etc.), or the like. As for the close proximity wireless communication, Felica®, Bluetooth®, RFID (Radio Frequency Identifier) and the like are used. Of course, other types of wireless communication may be used as the proximity wireless communication. The communication unit 14 may switch the communication method or the frequency band depending on a communication partner or the surrounding environments.

An UI unit 16 is a user interface unit and includes a display unit and an operation unit. The display unit is a display device such as a liquid crystal display. The display unit may be a flexible display. The operation unit is an input device such as a touch panel or a keyboard. The UI unit 16 may be a user interface that also serves as a display unit and an operation unit (including, e.g., a touch type display, a device that electronically displays a keyboard or the like on a display). Further, the UI unit 16 may include a sound collecting unit such as a microphone and a sound generating unit such as a speaker. In this case, information may be input to the terminal device 10 by voice input or may be output by voice.

A storage unit 18 is a storage device such as a hard disk drive or a memory (e.g., SSD, etc.). The storage unit 18 stores, for example, various data, various programs (e.g., OS (Operating System), various application programs (application software), etc.), information indicating addresses of other devices, information indicating an address of the server 12 (server address information), and the like. They may be stored in separate storage devices or may be stored in one storage device.

For example, an automatic response AI program (software) for implementing the automatic response AI is stored in the storage unit 18 and is executed to implement the function of the automatic response AI. The automatic response AI program may be stored in an external device such as the server 12 and may be executed by the external device so that the function of the automatic response AI can be provided from the external device to the terminal device 10. In this case, the automatic response AI program may not be stored in the storage unit 18.

In addition, the storage unit 18 stores determination criterion information. The determination criterion information is information indicating the determination criterion for a response from the automatic response AI functioning as a response assistant. The determination criterion includes one or more setting items. The setting items are, for example, age range, occupation, personality, character, environment and the like and are elements for determining attributes (properties and characteristics) of the automatic response AI. As will be described later, each setting item may be changed by a user. Each setting item will be described in detail later.

An SNS application program for using an SNS provided by the server 12 may be stored in the storage unit 18. When the SNS application program is executed, it becomes possible to use the SNS.

A control unit 20 has a function of controlling the operation of each unit of the terminal device 10. For example, the control unit 20 performs execution of various programs, control of communication by the communication unit 14, control of notification of information (e.g., display of information, sound output, etc.) using the UI unit 16, reception of information input using the UI unit 16, etc. For example, when the control unit 20 executes the automatic response AI program, the function of the automatic response AI is implemented. Further, the control unit 20 includes a changing unit 22.

The changing unit 22 has a function of changing the determination criterion (the contents of the setting items) for the response from the automatic response AI. Further, the changing unit 22 has a function of changing setting items each individually. For example, the changing unit 22 may change the determination criterion at the time of generating a chatbot or may change the determination criterion of the chatbot after the creation of the chatbot (i.e., after the chatbot starts to operate). That is, the changing unit 22 has a function of partially changing the determination criterion after the creation of the chatbot. Of course, the changing unit 22 may change the contents of all the setting items constituting the determination criterion. For example, the changing unit 22 changes the determination criterion (the contents of the setting items) according to a changing operation by a user.

The automatic response AI creates a response according to the determination criterion indicated by the determination criterion information and notifies the response to the user. That is, the automatic response AI has attributes determined by the contents of each setting item constituting the determination criterion and creates a response specific to the attributes. For example, in response to an inquiry from the user, the automatic response AI may notify the user of the detailed information based on the contents of a certain setting item (e.g., age range, occupation, personality, character, environment, etc.) as a response, may notify the user of a response within the range covering the contents of the setting item, or may preferentially notify the user of a response based on the contents of the setting item. That is, the automatic response AI has attributes determined by the contents of the setting items and may create the detailed information specific to the attributes as a response, may create a response within the range covering the attributes or may preferentially notify the user of a response specific to the attributes.

Further, the automatic response AI may guide the user so that the contents of communication with the user become the contents of communication related to the contents of the setting items. The automatic response AI may ask a question for the guidance or repeat the question. The automatic response AI may guide the user and repeat questions from the higher-level conceptual question (abstract question) to the lower-level conceptual question (more specific question) so as to obtain a more specific response. That is, the automatic response AI may output questions for deeper pursuit (analysis).

The automatic response AI may change the manner of response (language, term, buzzword, talking style, wording, etc.) according to the contents of the setting items. When the determination criterion (the contents of the setting items) is changed, the automatic response AI has attributes determined by the changed contents of the setting items, creates a response specific to the attributes and notifies the response to the user.

Hereinafter, the terminal device 10 according to the first exemplary embodiment will be described in detail.

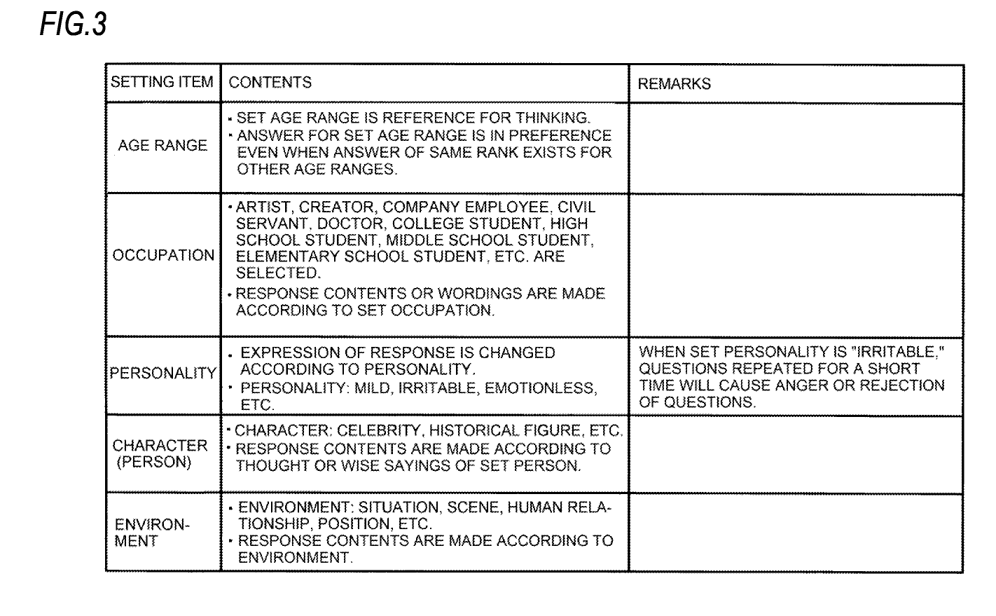

The setting items constituting the determination criterion will be described in detail with reference to FIG. 3. FIG. 3 illustrates each setting item. As described above, the determination criterion includes age range, occupation, personality, character (person), environment, and the like as the setting items. The information illustrated in FIG. 3 is stored in the storage unit 18 as determination criterion information. Each setting item will be described in detail below.

Age range is used as reference for thinking when the automatic response AI (e.g., a chatbot) creates a response. The age range may be set using the Christian age (e.g., the 1990's) or may be set using an era name (e.g., Heisei 10 s). Further, plural age ranges may be set, and date setting may be included in the age range setting. When the age range is set, the automatic response AI creates a response based on the set age range and notifies the user of the response. For example, the automatic response AI may extract detailed information related to the set age range (e.g., the 1990's) from a group of answers to a user's inquiry and notify it as a response, may notify information related to the set age range in preference to information related to other age ranges, or may create and notify a response corresponding to the user's inquiry within the range covering the set age range. For example, when there is an answer based on the set age range as an answer to the user's inquiry and there is an answer based on another age range as an answer with the same rank as the answer based on the set age range, the automatic response AI preferentially notifies the answer based on the set age range.

In addition, the automatic response AI may guide the user so that the contents of communication with the user becomes the contents of communication related to the set age range, and may repeat questions so as to obtain a more specific response.

Further, the automatic response AI may respond according to a response method adapted to the set age range. For example, the automatic response AI may respond using language, term (including buzzword or the like), talking style, wording, etc. used in the set age range.

As a specific example for the description, when “1990s” is set as the age range, the automatic response AI may notify the user of detailed information related to the 1990's in the response, or may notify the user of the information related to the 1990's in the response in preference to information related to other age ranges. For example, when the user inquires about incidents or news, the automatic response AI notifies the user of the information on the incidents and news occurred in the 1990's in the response. Even in the case of other inquiries, the automatic response AI notifies the user of the information related to the 1990's in the response. Further, the automatic response AI may guide the user so that the contents of communication with the user become the contents of communication related to the 1990's. Furthermore, the automatic response AI may respond using buzzwords, etc. in the 1990's.

The occupation is the reference occupation of thinking when the automatic response AI creates a response. As an example, the occupation is an artist, a creator, a company employee, a civil servant, a doctor, a student (college student, high school student, middle school student, elementary school student, etc.), etc. Of course, occupations other than these may be set. When the occupation is set, the automatic response AI creates a response based on the set occupation and notifies it to the user. That is, the automatic response AI responds in the position of the set occupation. For example, the automatic response AI may extract detailed information related to a set occupation (e.g., a doctor) from a group of answers to a user's inquiry and notify the information as a response, may notify the information related to the set occupation in preference to information related to other occupations, or may create and notify a response to the user's inquiry within the range covering the set occupation (e.g., within the performance of the occupation). For example, the contents and wordings of the response are made according to the set occupation. In addition, the automatic response AI may guide the user so that the contents of communication with the user become the contents of communication related to the set occupation. Further, the automatic response AI may respond according to the response method adapted to the set occupation. For example, the automatic response AI may respond using language, term (including terminology or the like), talking style, wording, etc. suitable for use in the set occupation.

An abstract level of occupation may be set or a more specific level of occupation may be set. For example, “company employee” corresponds to an abstract level of occupation, and “company employee whose business type is specified”, “company employee whose official position is specified”, “company employee whose experience years are specified” and so on correspond to a more specific level of occupation. “College student” corresponds to an abstract level of occupation, and “college student whose grade is specified”, “college student whose college name is specified”, “college student whose faculty or department is specified” and so on correspond to a more specific level of occupation. “Doctor” corresponds to an abstract level of occupation, and “doctor whose specialized field (surgery, internal medicine, etc.) is specified”, “doctor whose experience years are specified” and so on correspond to a more specific level of occupation. When the abstract level of occupation is set, the automatic response AI creates and outputs a response on the premise of, for example, the average or general ability or knowledge of the occupation. When the more specific level of occupation is set, the automatic response AI responds on the premise of the average or general ability or knowledge of the specific occupation.

As a specific example for the description, when “doctor” is set as an occupation, the automatic response AI responds in the position of a doctor. When “doctor” is set as an abstract level, the automatic response AI assumes a general or average doctor and responds in the position of the doctor. Specifically, the automatic response AI may notify the user of detailed medical information (e.g., information on disease, information on treatment, information on health, information on hospital, information on medication, etc.), and may notify the medical information in preference to other information. For example, when the user sends a symptom to the automatic response AI as the remark contents, the automatic response AI notifies the user of the medical information on the symptom in the response. For example, information on a disease estimated from the symptom, information on a hospital suitable for treatment of the disease, information on the treatment method, information on medication used for the treatment, and the like are notified to the user as medical information.

When a doctor is set as a more specific level of occupation, the automatic response AI responds in the position of the doctor according to the specific level. For example, when “physician” is set as an occupation, the automatic response AI assumes a general or average physician and responds in the position of the physician. It is assumed that the response obtained in this case is different from a response obtained when “surgeon”, “dentist”, etc. are set as occupations.

Further, the automatic response AI may guide the user so that the contents of communication with the user become the contents of communication related to medical treatment. For example, the automatic response AI may make a question such as “How is your condition?” as a higher level conceptual question related to health and may further make a lower level conceptual question (more specific question) in accordance with the contents of the user's remark on the higher level conceptual question. For example, when the user remarks “I am in bad condition”, the automatic response AI makes a question such as “Which part is bad?” as a still lower level conceptual question related to medical care. Thus, the automatic response AI can listen to a specific part in bad condition from the user. In response to the question, when the user remarks “I have a sore throat”, the automatic response AI specifies a disease (e.g., “cold”) inferred from “sore throat” as a still lower level conceptual question related to medical care and notifies the user of the disease name in the response. For example, a response such as “You have a cold” is notified. In addition, the automatic response AI may notify information on treatment method of cold, medicine, hospital, etc. in the response. Further, the automatic response AI may make a question such as “How much pain is it?”, “Do you have a fever?” or “Do you have a headache?” as a further lower level conceptual question related to medical care. Thus, the automatic response AI may acquire information about a more specific symptom from the user. That is, the automatic response AI can pursue (analyze) the symptom of the user more deeply. In addition, when the user inquires about a hospital, the automatic response AI may notify a response such as “Special hospital is XX”, “Nearby hospital is YY” or “Now, hospital doing medical treatment is ZZ”.

In addition, the automatic response AI may respond using terminologies used by doctors. Of course, general terms other than terminologies may be used depending on the relationship between the doctor and the user. For example, in a case where the user's occupation is set, when there is a relationship between the occupation set in the automatic response AI and the user's occupation, the automatic response AI responds using the terminologies. When there is no relationship therebetween, the automatic response AI responds using general terms. The relationship is determined based on business type, occupation type, employment history, presence or absence of student, grade, academic background, etc. The determination is made by the automatic response AI. For example, when a doctor is set as an occupation of the automatic response AI and a medical occupation (e.g., a doctor, a nurse, etc.) is set as an occupation of the user, the automatic response AI responds using the terminologies. In the meantime, when an occupation other than medical care is set as the occupation of the user, the automatic response AI responds using general terms.

Here, another specific example of a process of guiding the user will be described. For example, when an “English teacher” is set as an occupation, the automatic response AI preferentially notifies information on English learning (e.g., English learning method, information on a reference book, information on an English conversation school, etc.). For example, when the user remarks “Tell me how to study English”, the automatic response AI makes a question such as “English conversation?, English grammar?, English composition?” as a higher level conceptual question about English learning. In response to the question, when the user remarks “English conversation”, the automatic response AI makes a question such as “Everyday conversation?, business English conversation?” as a lower level conceptual question about English learning. In response to the question, when the user remarks “Business English conversation”, the automatic response AI makes a question such as “What kind of scene do you anticipate?” as a further lower level conceptual question. In response to this question, when the user remarks “presentation”, the automatic response AI may notify information on reference books useful for presentation using English and information on English conversation schools for learning English presentation methods in the response. In this way, by asking a lower level conceptual question from a higher level conceptual question, the automatic response AI can listen to a specific request of the user and accordingly can notify a more specific response.

The personality is the reference personality of thinking when the automatic response AI creates a response. The personality is, for example, mild, irritable, emotionless, etc. Of course, other personalities may be set. When the personality is set, the automatic response AI creates and notifies a response based on the set personality. That is, the automatic response AI assumes a character having the personality as an attribute and changes a response method (e.g., expression) according to the assumed character. For example, when “mild” is set as the personality, the automatic response AI responds using a mild expression (e.g., a gentle expression). In the meantime, when “irritable” is set as the personality, the automatic response AI responds using an unfriendly expression. In addition, in the case where “irritable” is set as the personality, when the user sends plural questions to the automatic response AI for a short time (e.g., for a predetermined time), the automatic response AI may notify a message representing an anger in the response or may not accept (ignore) the questions from the user.

The character (person) is the reference character (reference person) of thinking when the automatic response AI creates a response. The character is, for example, a celebrity, a historical figure, etc. Specifically, the character is a politician, a scholar, a writer, an entrepreneur, an actor, an artist (a musician, a painter, etc.), an entertainer, an athlete or the like. Of course, other characters may be set. When the character (person) is set, the automatic response AI creates and notifies a response based on the set person. That is, the automatic response AI responds in the position of the set person. For example, the automatic response AI changes the contents of a response according to the thought and wise sayings of the set person. The automatic response AI may create a response with the wise sayings of the set person and notify it to the user, or may create a response based on the thought of the set person (the thought assumed to be possessed by the person) and notify it to the user. Specifically, when a certain military commander is set as the person, the automatic response AI may create a response with the wise sayings of the military commander, or may create a response based on the thought assumed to be possessed by the military commander.

The environment is the reference environment of thinking when the automatic response AI creates a response. The environment is, for example, a situation, a scene, a human relationship, a position, etc. Of course, other environments may be set. When the environment is set, the automatic response AI creates a response based on the set environment and notifies it to the user. For example, the automatic response AI changes the contents of a response according to the set environment. Further, the automatic response AI may respond according to a response method adapted to the set environment. For example, the automatic response AI may respond using language, term, talking style, wording, etc. suitable for use in the set environment.

As a specific example for the description, when “the relationship between a supervisor and a subordinate in a workplace” is set as the environment, the automatic response AI may respond using an expression representing the hierarchical relationship between a supervisor and a subordinate or may create and notify the contents according to the hierarchical relationship in the response. For example, when the automatic response AI is set as a supervisor, the automatic response AI responds using an expression representing the supervisor. In addition, the automatic response AI may notify the response contents according to the knowledge level and experience level assumed to be possessed by the supervisor. When the automatic response AI is set as a subordinate, the automatic response AI responds using an expression representing the subordinate. In addition, the automatic response AI may notify the response contents according to the knowledge level and the experience level assumed to be possessed by the subordinate.

Setting items other than the above-described setting items may be used as the determination criterion. For example, gender or age may be used as the determination criterion. When the gender is set, the automatic response AI changes the response contents or a response method according to the gender. That is, the automatic response AI responds in the position of a person having the gender. When the gender is male, the automatic response AI may create and notify a response according to the thought of the male (e.g., the values and hobbies assumed to be possessed by the male) or may notify a response with a mannish expression. When the gender is female, the automatic response AI may create a response according to the thought of the female or may notify a response with a feminine expression. When the age is set, the automatic response AI changes the response contents and a response method according to the age. That is, the automatic response AI responds in the position of a person of that age. For example, when the age is in the late teens, the automatic response AI may create and notify a response according to the thought of a person in the late teens (e.g., the values and hobbies assumed to be possessed by the person in the late teens) or may notify a response with an expression made by the person in the late teens. When the age is in the late 50's, the automatic response AI may create and notify a response according to the thought of a person in the late 50's or may notify a response with an expression made by the person in the late 50's.

As for other setting items, a setting item related to medicine, a setting item related to traffic, a setting item related to politics, a setting item related to shopping and the like may be set. For example, when the latest knowledge is set as the setting item related to medicine, the automatic response AI responds based on the latest medical knowledge. When the latest knowledge is set as the setting item related to traffic, the automatic response AI notifies the latest traffic information in the response. When the latest knowledge is set as the setting item related to politics, the automatic response AI responds based on the latest political circumstances. When the latest information is set as the setting item related to shopping, the automatic response AI notifies the latest information on shopping (e.g., the latest information on shopping sites, the latest information on products, etc.) in the response. The user may also set these setting items each individually.

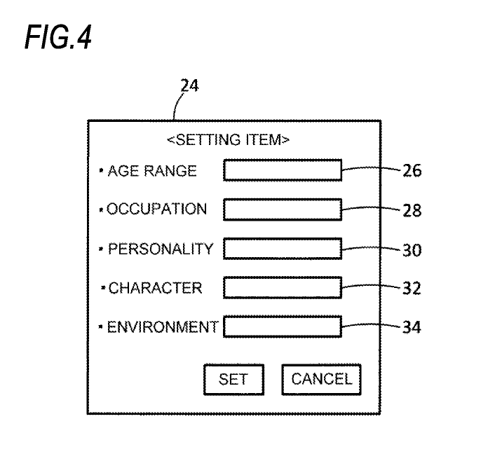

Hereinafter, a screen for setting the determination criterion (setting items) will be described with reference to FIG. 4. The screen 24 is illustrated in FIG. 4. When a user uses the UI unit 16 to give a display instruction of the screen 24, the control unit 20 displays the screen 24 on the display unit of the UI unit 16. Entry fields for setting the setting items are displayed on the screen 24. For example, an entry field 26 is a field for setting the age range. An entry field 28 is a field for setting the occupation. An entry field 30 is a field for setting the personality. An entry field 32 is a field for setting the character (person). An entry field 34 is a field for setting the environment. In this way, the contents of the setting items may be each individually set by the user.

The user uses the UI unit 16 to input a setting content in each entry field. For example, a list of candidates of setting contents is displayed in each entry field according to a pull-down method and the user selects a setting content from the list. The selected setting content is used as the determination criterion. For example, when the user designates the age range entry field 26, the control unit 20 displays a list of age ranges (e.g., 1970's, 1980's, 1990's, etc.) on the screen 24. When the user selects a certain age range (e.g., 1990's) from the list, the changing unit 22 sets the age range as the determination criterion of the automatic response AI. Of course, the user may directly input the setting content in each entry field. When the user presses a setting button on the screen 24, the setting content input in each entry field is set as the determination reference.

The changing unit 22 sets the age range input in the entry field 26, the occupation input in the entry field 28, the personality input in the entry field 30, the character input in the entry field 32 and the environment input in the entry field 34 as determination criteria of the automatic response AI.

The user may set all the setting items or may set some setting items but not other setting items. A setting item set by the user is used as the determination criterion of the automatic response AI. A setting item not set by the user is not used as the determination criterion and the automatic response AI creates a response indicating that it does not have the attribute of the setting item. For example, when the occupation is set, the automatic response AI responds using the set occupation as the criterion. In the meantime, when no occupation is set, the automatic response AI responds without limiting the occupation.

The user may set each setting item by giving a display instruction of the screen 24 at the time of creating the automatic response AI (e.g., a chatbot). In addition, the user may set each setting item by giving a display instruction of the screen 24 after the creation of the automatic response AI. For example, when the user gives a display instruction of the screen 24 during communication with the automatic response AI, the control unit 20 displays the screen 24 on the display unit. When the user changes the contents of the setting item on the screen 24, the changing unit 22 sets the changed contents of the setting item as the determination criterion of the automatic response AI. After that, the automatic response AI responds according to the changed contents of the setting item. In this manner, even after the automatic response AI is created, the setting items may be each individually changed.

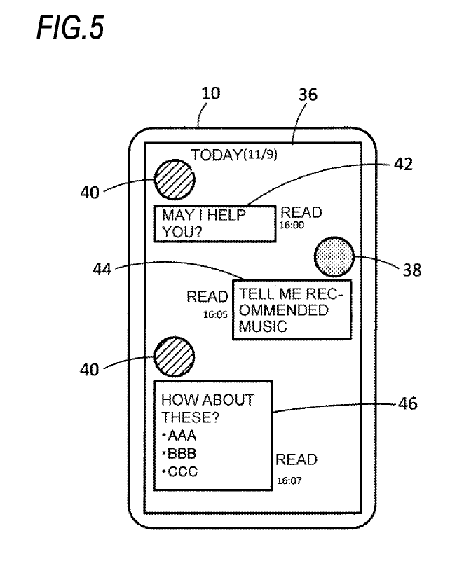

Hereinafter, a screen displayed on the terminal device 10 when using the automatic response AI will be described in detail with reference to FIG. 5. The screen 36 is illustrated in FIG. 5. The control unit 20 displays the screen 36 on the display unit of the UI unit 16 and displays various kinds of information on the screen 36. The screen 36 is an interface (communication response screen) for the user to interact with the automatic response AI. Information input by the user to the terminal device 10 (e.g., character string, image, etc.) and information indicating the contents of remarks of the automatic response AI (e.g., character string, image, etc.) are displayed on the screen 36. The communication between the user and the automatic response AI may be a so-called chatting type communication (i.e., a real-time communication, in other words, a communication of a form in which the communication progresses while the user and the automatic response AI are talking with each other). For example, when the user gives an instruction to execute an automatic respons e AI program (e.g., a chatting program), the control unit 20 executes the automatic response AI program and displays the screen 36 for communication with the automatic response AI on the display unit.

When the automatic response AI (e.g., a chatbot) has already been created, the control unit 20 displays the screen 36 for communication on the display unit in accordance with the instruction to execute the automatic response AI program. When the automatic response AI has not yet been created, the control unit 20 displays a screen for creation of the automatic response AI on the display unit. For example, the control unit 20 displays the screen 24 illustrated in FIG. 4 on the display unit. When the user sets each setting item on the screen 24, the control unit 20 creates the automatic response AI having the contents of each setting item set by the user as the determination criterion, and displays the screen 36 for communication with the automatic response AI on the display unit. The automatic response AI program may be executed by an external device such as the server 12. In this case, the information on the screen 36 is transmitted from the external device to the terminal device 10 and the screen 36 is displayed on the display unit of the terminal device 10.

The control unit 20 causes an image 38 associated with the user and an image 40 associated with the automatic response AI to be displayed on the screen 36. The image 38 is an image for identifying the user and the image 40 is an image for identifying the automatic response AI. Instead of or in addition to the image 38, a character string indicating the user (e.g., a character string for identifying the user, such as a name, a user ID, a handle name and a nickname) may be displayed. Further, the character string “user” may be displayed. Similarly, instead of or in addition to the image 40, a character string indicating the automatic response AI (e.g., a character string such as a character string “bot”) may be displayed.

The image 38 associated with the user is displayed in an area allocated to the user using the terminal device 10 in the screen 36 and the image 40 associated with the automatic response AI is displayed in an area allocated to the automatic response AI in the screen 36.

In the example illustrated in FIG. 5, the area for the user is set in the right side of the screen 36 and the image 38 associated with the user is displayed in the right side area. The contents of the user's remark are associated with the image 38 and are displayed in the right side area. The area for the automatic response AI is set in the left side of the screen 36 and the image 40 associated with the automatic response AI is displayed in the left side area. The contents of remarks of the automatic response AI are associated with the image 40 and are displayed in the left side area. Of course, this display example is merely illustrative. The arrangement relationship of the areas may be reversed, the areas may be set in the vertical direction, all or some of the areas may overlap with each other, and the latest remark contents may be displayed in a specific area (e.g., the central area) of the screen 36 and the past remark contents may be displayed around the specific area. In addition, the areas may have the same or different sizes or may be enlarged or reduced depending on the amount of remark contents and the number of remarks. The setting and size of the areas are controlled by the control unit 20.

In the example illustrated in FIG. 5, although interlocutors are one user and one automatic response AI, plural users and plural automatic response AIs may participate in the communication. In this case, an area for each interlocutor may be provided on the screen 36. For example, when two users and one automatic response AI are participating in the communication, three areas are set on the screen 36 and the contents of a remark of each interlocutor is displayed in its own area. For example, when plural users interact with each other via the screen 36 by performing communication between plural terminal devices 10, the contents of remarks of the plural users are displayed on the screen 36. The same is true when plural automatic response AIs participate in the communication. A program related to the plural automatic response AIs may be installed in the same terminal device 10 and the plural automatic response AIs may be stored in the same terminal device 10. Alternatively, programs related to the plural automatic response AIs may be installed in different terminal devices 10 and the plural automatic response AIs may be stored in the different terminal devices 10. For example, the contents of a remark of the automatic response AI stored in the terminal device 10 and the contents of a remark of an automatic response AI stored in another terminal device 10 are displayed on the screen 36. The automatic response AI stored in the other terminal device 10 participates in the communication, for example, via the communication path N.

Thereafter, the communication is made between the user and the automatic response AI. In the communication, the user may input the contents of a remark by operating the UI unit 16 to input a character string, an image or the like, or may input the remark contents by voice. In addition, the user's remark contents may or may not be displayed on the screen 36 as information of a character string, an image or the like. Similarly, the contents of a remark of the automatic response AI may be displayed on the screen 36 as information of a character string, an image or the like, or may be uttered by voice without being displayed or with being displayed. In the following description, as an example, it is assumed that the contents of remarks of interlocutors are displayed on the screen 36, but they may be uttered by voice.

The remark contents are displayed in time series according to the transmission date and time. For example, the date and time when the user sent his own remark contents to the automatic response AI corresponds to the transmission date and time of the user's remark contents. Further, the date and time when the automatic response AI creates a response or the date and time when the remark contents as the response is displayed on the screen 36 corresponds to the transmission date and time of the remark contents of the automatic response AI.

When the communication progresses on the screen 36, the control unit 20 scrolls the screen 36 to display the latest remark contents or the most recent remark contents on the screen 36. Accordingly, the past remark contents that cannot be all displayed on the screen 36 are not displayed on the screen 36.

When the automatic response AI program is started, for example, the automatic response AI outputs a general question (a question asking a user's request) such as “May I help you?”, and a character string indicating the question is displayed on the screen 36 as the remark content 42 from the automatic response AI. Of course, instead of or in addition to the character string, the remark contents of the automatic response AI may be uttered by voice. Since the remark contents 42 are the remark contents of the automatic response AI, the control unit 20 displays the remark contents 42 on the screen 36 in association with the image 40 of the automatic response AI. The same is true of the following communication.

Next, when the user remarks “Tell me recommended music” or the like, a character string indicating the contents thereof is displayed on the screen 36 as the user's remark contents 44. For example, the user may input the remark contents 44 to the terminal device 10 by operating the screen 36 to input the character string, or may input the remark contents 44 to the terminal device 10 by voice. Since the remark contents 44 are the user's remark contents, the control unit 20 displays the remark contents 44 on the screen 36 in association with the image 38 of the user. The same is true of the following communication.

The remark contents 46 are the remark contents of the automatic response AI and are displayed on the screen 36 in association with the image 40 of the automatic response AI.

In the example illustrated in FIG. 5, the remark contents 42, 44 and 46 are output in this order and are displayed in time series according to the date and time (transmission date and time) when the remark contents 42, 44 and 46 are output. The same is true of later remark contents.

The automatic response AI identifies a user's inquiry by analyzing the user's remark contents 44 and creates a response to the inquiry. At this time, the automatic response AI creates a response according to the set determination criterion (the contents of each setting item). As an example, it is assumed that the age range as the determination criterion is set to the “1990's”. In this case, the automatic response AI creates a response to the user's inquiry (recommended music) based on the 1990's. Specifically, the automatic response AI notifies the user of detailed information related to the 1990's in the response, in preference to information related to other age ranges. The automatic response AI analyzes the user's remark contents 44 and searches for “recommended music” related to the 1990's. For example, the automatic response AI searches for songs hit in the 1990's (popular songs, songs that had high sales, award winning songs, etc.), as recommended songs in the 1990's, and notifies the user of information on those songs in the response in preference to other songs. Even when there are songs (recommended music) hit in the age ranges other than the 1990's, the automatic response AI answers with the songs hit in the 1990's in preference to songs hit in other age ranges. Information (a character string indicating song titles AAA, BBB, CCC, etc.) indicating the songs hit in the 1990's is displayed on the screen 36 as the remark contents 46 of the automatic response AI. By doing so, even when the user does not specify an age range during the communication with the automatic response AI, the detailed information on the set age range is notified to the user preferentially with respect to the user's inquiry. In addition, the automatic response AI may create a response to the user's inquiry within the range of the 1990's. The automatic response AI may use the Internet or the like to search for recommended songs in the 1990's or may search for recommended songs in the 1990's from music data stored in the terminal device 10. The automatic response AI may acquire information on recommended songs in the 1990's from another automatic response AI stored in another device by communicating with the another automatic response AI. Even when setting items other than the age range are set, as with the age range, the automatic response AI creates a response based on the contents of the setting items and notifies it to the user.

In addition, when the user gives an instruction to change the determination criterion during the communication with the automatic response AI, the changing unit 22 changes the determination criterion according to the change instruction. For example, when the user changes the age range to the 1980's, the changing unit 22 changes the contents of the setting item related to the age range to the 1980's. The automatic response AI responds according to the changed determination criterion. For example, when the user inquires of recommended music, the automatic response AI answers with songs hit in the 1980's. In this manner, even after the automatic response AI is created, the user may each individually change the contents of the setting items constituting the determination criterion, and the automatic response AI may respond in accordance with the changed determination criterion.

Information indicating the time when the remark contents are transmitted (e.g., the time of day and the date and time) may be displayed on the screen 36. For example, a character string indicating a date (e.g., today's date, November 9) is displayed on the screen 36. The remark contents displayed below the display position of the character string indicating the date are the remark contents transmitted after that date and the remark contents displayed above the display position are the remark contents transmitted before that date. For example, the remark contents 42 are output (transmitted) at 16:00 on November 9 by the automatic response AI, and information indicating the time is displayed in association with the remark contents 42. For example, the information indicating the time is displayed in the vicinity of the remark contents 42. Similarly, for other remark contents, information indicating the transmission time is displayed. Of course, the information indicating the time of day and the date and time may not be displayed.

In addition, read and unread of the remark contents may be managed. Here, a read message and an unread message will be described. The read message is the remark contents read by a person other than the sender of the remark contents (communication partner) and the unread message is the remark contents not read by a person other than the sender. For example, when the automatic response AI begins to analyze the remark contents after the user transmits the remark contents, the control unit 20 determines that the remark contents of the user have been read by the automatic response AI. In addition, after the remark contents output by the automatic response AI are displayed on the screen 36, when the user designates the remark contents on the screen 36, displays the designated remark contents on a separate window (separate screen), or gives an instruction of read, the control unit 20 determines that the remark contents of the automatic response AI have been read by the user. As another example, after a confirmation message indicating that the automatic response AI has remarked is displayed on the display unit, when the user gives an instruction to display the remark contents or when the remark contents are actually displayed on the screen 36, the control unit 20 may determine that the remark contents of the automatic response AI have been read by the user.

When determining that the remark contents have been read by the communication partner, the control unit 20 displays the read information indicating that the remark contents have been read by the communication partner (character string, image, etc.) on the screen 36 associated with the remark contents. In the example illustrated in FIG. 5, it is determined that the remark contents 42 and 46 of the automatic response AI have been read by the user and that the remark contents 44 of the user have been read by the automatic response AI. Accordingly, the read information (e.g., the character string “read”) is displayed in association with each of the remark contents 42, 44 and 46. For example, the read information is displayed in the vicinity of each of the remark contents.

The remark contents with which the read information is associated correspond to the read message and a message with which the read information is not associated corresponds to the unread message.

The control unit 20 may display the unread information indicating that the remark contents have not been read by the communication partner on the screen 36 in association with the unread message. In addition, the read information may be displayed in association with the read message, and the unread information may be displayed in association with the unread message, or one of the read information and the unread information may be displayed.

In the example illustrated in FIG. 5, the read information is displayed as a character string in association with the remark contents. However, a method other than the method using the character string may be used to express the read information. For example, the control unit 20 may change the expression form between the read message and the unread message. Specifically, the control unit 20 may express a character string included in the unread message with a specific font, or may express the character string with a specific color, or may express the character string in boldface. In addition, the control unit 20 may decorate the display frame of the unread message or may highlight the unread message. Thus, the read message and the unread message are distinguished from each other. Of course, the control unit 20 may apply the above process to the read message but may not apply the above process to the unread message. Further, the control unit 20 may execute the above process while displaying the read information and the unread information.

While the read information and the unread information on the user's remark contents are being displayed on the screen 36, the read information or the unread information on the remark contents of the automatic response AI may be displayed on the screen 36 or the read information or the unread information on the remark contents of one of the user and the automatic response AI may be displayed on the screen 36. The read information and the unread information may not be displayed.

According to the present exemplary embodiment, the user may each individually change the contents of the setting items constituting the determination criterion of the automatic response AI. Accordingly, a response is obtained from the automatic response AI at a request from the user.

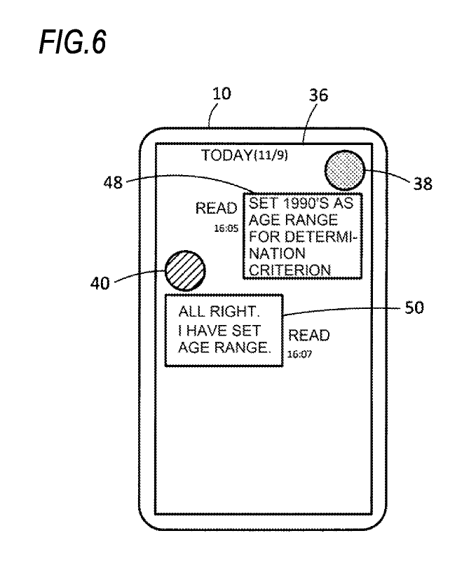

The changing unit 22 may change the determination criterion based on the communication between the user and the automatic response AI. Hereinafter, this changing process will be described with reference to FIG. 6. A screen 36 is illustrated in FIG. 6. For example, when the user remarks “Set the age range for the determination criterion to the 1990's”, a character string indicating the contents thereof is displayed on the screen 36 as the user's remark contents 48. The automatic response AI identifies the user's inquiry by analyzing the user's remark contents 48. In the example illustrated in FIG. 6, since the user requests that the age range for the determination criterion be set to the 1990's, the changing unit 22 sets the age range for the determination criterion to the 1990's. Hereafter, the automatic response AI creates a response based on the 1990's. The remark contents 50 of the automatic response AI indicating that the setting is completed may be displayed on the screen 36. Since the determination criterion may be changed during the communication with the automatic response AI, it is not necessary to display a screen for changing the determination criterion.

In the exemplary embodiment described above, the determination criterion is changed by the user. However, the determination criterion may be automatically changed. For example, the changing unit 22 may change the determination criterion according to the attributes of the user, the history of communication with the automatic response AI, and the like.

The attributes of the user are the user's age, gender, occupation (including student), personality and the like. Information indicating the attributes of the user is stored in, for example, the storage unit 18.

For example, the changing unit 22 changes the age range or occupation as the determination criterion according to the age of the user. Specifically, when the age of the user is in teenage, the changing unit 22 sets the age range for the determination criterion to an age range when the user is born, an age range when the user is an elementary school student, a middle school student or a high school student, etc. In addition, the changing unit 22 may set the occupation as the determination criterion to student. By changing the age range or occupation as the determination criterion according to the age of the user, a response suitable for the age of the user may be easily obtained from the automatic response AI.

Further, the changing unit 22 may change the gender as the determination criterion according to the gender of the user. The changing unit 22 may set the same gender as the user as the determination criterion or may set a different gender as the determination criterion. When the same gender as the user is set as the determination criterion, a response from a communication partner of the same gender is obtained. When a gender different from the gender of the user is set as the determination criterion, a response from a communication partner of a different gender is obtained.

Further, the changing unit 22 may change the occupation as the determination criterion according to the occupation of the user. Specifically, when the occupation of the user is a doctor, the changing unit 22 sets the occupation as the determination criterion to a doctor. By changing the occupation as the determination criterion according to the occupation of the user, a response suitable for the occupation of the user may be easily obtained from the automatic response AI. For example, a response including terminologies and the like used in the occupation of the user is obtained.

Further, the changing unit 22 may change the personality as the determination criterion according to the personality of the user. The changing unit 22 may set the same or similar personality as the user as the determination criterion or may set a different personality as the determination criterion. When the same or similar personality as the user is set as the determination criterion, a response from a communication partner having the same or similar personality as the user is obtained. When a different personality from the user is set as the determination criterion, a response from a communication partner having a different personality from the user is obtained.

In addition, the changing unit 22 may change the age or gender for the determination criterion according to the attributes of the user. The changing unit 22 may set the same age as the user for the determination criterion or may set a different age for the determination criterion. Further, the changing unit 22 may set, as the age for the determination criterion, an age range of the same generation as the user. For example, when the age of the user is in teenage, the changing unit 22 sets the age range of the automatic response AI to teenage. Thus, a response from a communication partner of the same generation as the user is obtained. Further, the changing unit 22 may set, as the age for the determination criterion, an age higher than the age of the user or an age range higher than the user. Thus, a response from a communication partner of a generation older than the user is obtained. Contrarily, the changing unit 22 may set, as the age for the determination criterion, an age lower than the age of the user or a generation younger than the user. Thus, a response from a communication partner of a generation younger than the user is obtained.

The automatic response AI estimates the age, gender, occupation, personality and the like of the user based on the history of communication with the user and the changing unit 22 may change the determination criterion based on results of the estimation.

As described above, by changing the determination criterion according to the attributes of the user, a response adapted for the attributes of the user may be easily obtained.

In addition, the changing unit 22 may change the determination criterion according to the user's address, nationality, language used and the like.

The above-mentioned determination criterion may be set for different users. For example, user identification information for identifying a user and information indicating a determination criterion for the user are stored in the storage unit 18 in association. The user identification information is, for example, user account information, user ID, user name and the like. For example, the changing unit 22 changes the determination criterion of the automatic response AI to the determination criterion associated with the identification information of a user logged in the terminal device 10. For example, by registering the user identification information on the screen 24 illustrated in FIG. 4, the determination criterion is set for each user. When the determination criterion is set for each user account, the changing unit 22 changes the determination criterion of the automatic response AI to the determination criterion associated with the user account that is logged in to the terminal device 10. When plural user accounts are associated with the same user, the determination criterion associated with the user account used to log in to the terminal device 10 is used. That is, even when the same user logs in to the terminal device 10, different determination criteria are used as long as the user accounts used for the login are different from each other.

### Second Exemplary Embodiment

Hereinafter, an information processing system according to a second exemplary embodiment will be described. In the second exemplary embodiment, the automatic response AI responds by voice. For example, the voice is emitted from the speaker of the UI unit 16. Further, in the second exemplary embodiment, the changing unit 22 changes the way of generating a voice of the automatic response AI at the time of response according to the setting of the automatic response AI. For example, when the determination criterion for the response from the automatic response AI (the contents of setting items) is changed, the changing unit 22 changes the way of generating the voice of the automatic response AI, according to the changed determination criterion. As a result, the voice expressing the response from the automatic response AI is output in the changed way of generating the voice. More specifically, the changing unit 22 changes the way of generating the voice of the automatic response AI to a way of generating the voice according to at least one setting item among a setting item group including the age range, occupation, personality, character and environment. Of course, the changing unit 22 may change the way of generating the voice of the automatic response AI to a way of generating the voice according to other setting items.

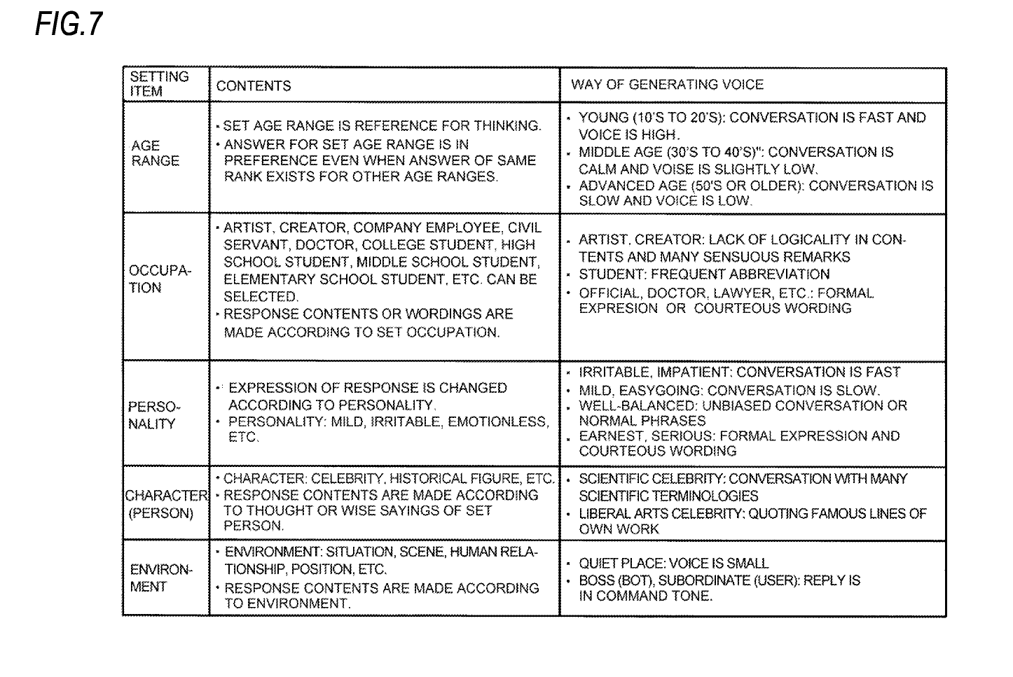

How to generate a voice for each setting item will be described with reference to FIG. 7. FIG. 7 illustrates how to generate the voice for each setting item. Information illustrated in FIG. 7 is stored as determination criterion information in the storage unit 18.

When the age range is set, the changing unit 22 changes the way of generating the voice of the automatic response AI to a way of generating the voice according to the set age range. Thus, the voice expressing the response from the automatic response AI is output according to the way of generating the voice according to the set age range. For example, when “young age (e.g., 10's to 20's)” is set as the age range, the changing unit 22 changes the way of generating the voice of the automatic response AI to a way of generating voice in such a manner that “conversation is fast and voice is high”. When “middle age (e.g., 30's to 40's)” is set as the age range, the changing unit 22 changes the way of generating the voice of the automatic response AI to a way of generating voice in such a manner that “conversation is calm and voice is slightly low”. When “advanced age (e.g., 50's or older)” is set as the age range, the changing unit 22 changes the way of generating the voice of the automatic response AI to a way of generating voice in such a manner that “conversation is slow and voice is low”.

As a specific example for the description, when “1990's” is set as the age range, the changing unit 22 changes the way of generating the voice of the automatic response AI to a way of generating voice according to the age range of the user in the “1990's”. For example, when the current age of the user is 50, the age range of the user in the 1990's is “20's”. Thus, the changing unit 22 changes the way of generating the voice of the automatic response AI to a way of generating voice according to “20's”. Thus, the voice of the automatic response AI is generated and output according to the age range of the user in the 1990's. The user's age range is preset, for example, via the UI unit 16. Of course, the changing unit 22 may change the way of generating the voice of the automatic response AI to a way of generating voice according to the current age range of the user. In the above example, the changing unit 22 may change the way of generating the voice of the automatic response AI to a way of generating voice according to “50's”. Thus, the voice of the automatic response AI is generated and output according to the current age range of the user.

When the occupation is set, the changing unit 22 changes the way of generating the voice of the automatic response AI to a way of generating voice according to the set occupation. Thus, the voice expressing the response from the automatic response AI is output according to the way of generating voice according to the set occupation. For example, when “artist or creator” is set as the occupation, the changing unit 22 changes the way of generating the voice of the automatic response AI to a way of generating voice with “lack of logicality in contents and many sensuous remarks”. When “student” is set as the occupation, the changing unit 22 changes the way of generating the voice of the automatic response AI to a way of generating voice with “frequent abbreviation”. When “official, doctor, lawyer, etc.” is set as the occupation, the changing unit 22 changes the way of generating the voice of the automatic response AI to a way of generating voice with “formal expression and courteous wording”.

When the personality is set, the changing unit 22 changes the way of generating the voice of the automatic response AI to a way of generating voice according to the set personality. Thus, the voice expressing the response from the automatic response AI is output according to the way of generating voice according to the set personality. For example, when “irritable or impatient” is set as the personality, the changing unit 22 changes the way of generating the voice of the automatic response AI to a way of generating voice in such a manner that “conversation is fast”. When “mild or easygoing” is set as the personality, the changing unit 22 changes the way of generating the voice of the automatic response AI to a way of generating voice in such a manner that “conversation is slow”. When “well-balanced” is set as the personality, the changing unit 22 changes the way of generating the voice of the automatic response AI to a way of generating voice with “unbiased conversation or normal phrases”. When “earnest or serious” is set as the personality, the changing unit 22 changes the way of generating the voice of the automatic response AI to a way of generating voice with “formal expression or courteous wording”.

When the character is set, the changing unit 22 changes the way of generating the voice of the automatic response AI to a way of generating voice according to the set character. Thus, the voice expressing the response from the automatic response AI is output according to the way of generating voice according to the set character. For example, when a “scientific celebrity” is set as the character, the changing unit 22 changes the way of generating the voice of the automatic response AI to a way of generating voice with “conversation with many scientific terminologies”. When “liberal arts celebrity” is set as the character, the changing unit 22 changes the way of generating the voice of the automatic response AI to a way of generating voice with “quoting famous lines of own work”.

When the environment is set, the changing unit 22 changes the way of generating the voice of the automatic response AI to a way of generating voice according to the set environment. Thus, the voice expressing the response from the automatic response AI is output according to the way of generating voice according to the set environment. For example, when “quiet place” is set as the environment, the changing unit 22 changes the way of generating the voice of the automatic response AI to a way of generating voice in such a manner that “voice is small”. When “the bot is a boss and the user is a subordinate” is set as the environment, the changing unit 22 changes the way of generating the voice of the automatic response AI to a way of generating voice in such a manner that “reply is in command tone”.

Setting items other than the above-mentioned setting items may be used as the determination criteria. For example, when the gender is set, the changing unit 22 changes the way of generating the voice of the automatic response AI to a way of generating voice according to the set gender. As a specific example for the description, when “male” is set as the gender, the changing unit 22 changes the voice of the automatic response AI to “male voice” and sets a way of generating voice according to “male expressions”. When “female” is set as the gender, the changing unit 22 changes the voice of the automatic response AI to “female voice” and sets a way of generating voice according to “female expressions”. Of course, animals other than humans may be set as setting items. In this case, the changing unit 22 changes the way of generating the voice of the automatic response AI to a way of generating the voice of the set animal. For example, when “cat” is set as the animal, the changing unit 22 changes the way of generating the voice of the automatic response AI to a way of generating the voice (e.g., cry) of “cat”.

When the determination criterion is set for each user, the changing unit 22 changes the way of generating the voice of the automatic response AI for each user. For example, when a user A is interacting with the automatic response AI (e.g., when the user A logs in to the terminal device 10), the changing unit 22 changes the way of generating the voice of the automatic response AI according to a determination criterion associated with the user A. When another user B is interacting with the automatic response AI (e.g., when the user B logs in to the terminal device 10), the changing unit 22 changes the way of generating the voice of the automatic response AI according to a determination criterion associated with the user B.

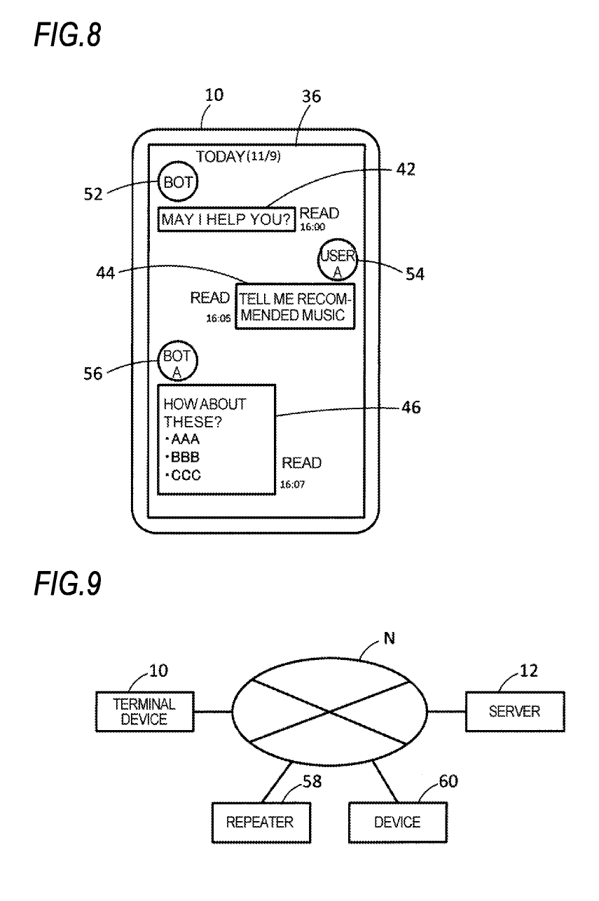

Hereinafter, a specific example will be described with reference to FIG. 8. The screen 36 is illustrated in FIG. 8. The remark contents 42, 44 and 46 illustrated in FIG. 8 have the same as the remark contents illustrated in FIG. 5.

First, an automatic response AI not associated with a user (a bot not associated with the user or a bot independent of the user) outputs a remark content 42 saying “May I help you?” The control unit 20 displays an image 52 associated with the automatic response AI not associated with the user on the screen 36 and displays the remark contents 42 on the screen 36 in association with the image 52. The image 52 is an image for identifying the automatic response AI not associated with the user. In addition, the automatic response AI not associated with the user outputs the remark contents 42 by voice according to a predetermined way of generating the voice. For example, the voice is emitted from a speaker provided in the UI unit 16.

For example, when the user A logs in to the terminal device 10 and the remark contents 44 of “Tell me recommended music” are output for the remark contents 42, the control unit 20 displays an image 54 associated with the user A on the screen 36 and displays the remark contents 44 on the screen 36 in association with the image 54. The image 54 is an image for identifying the user A. For example, the image 54 may be a picture of the user A or an image of a character associated with the user A (e.g., an avatar, etc.).

An answer of the automatic response AI to an inquiry of the user A is displayed on the screen 36 as the remark contents 46. As described with reference to FIG. 5, for example, when the age range for the determination criterion is set to “1990's”, the information indicating songs hit in the 1990's is displayed as the remark contents 46 of the automatic response AI. Since the user A logs in to the terminal device 10, the control unit 20 displays an image 56 associated with the automatic response AI associated with the user A on the screen 36, instead of the image 52 associated with the automatic response AI not associated with the user, and displays the remark contents 46 on the screen 36 in association with the image 56. The image 56 is an image for identifying the automatic response AI associated with the user A. The image 52 may be displayed without displaying the image 56.

The automatic response AI associated with the user A outputs the remark contents 46 by voice according to the way of generating the voice according to the determination criterion associated with the user A. When the age range is set as described above, the automatic response AI associated with the user A outputs the remark contents 46 by voice according to a way of generating voice according to the age range. For example, the voice is output from a speaker provided in the UI unit 16. For example, the automatic response AI associated with the user A outputs the remark contents 46 according to the way of generating voice according to the age range of the user A in the “1990's”. The age of the user A is set, for example, when the determination criterion for the user A is set.

According to the second exemplary embodiment, when the automatic response AI outputs a response by voice, the voice is output according to the way of generating voice according to the set determination criterion. Thus, it becomes easier for the user to audibly recognize the set determination criterion than a case where the automatic response AI outputs voice in a constant way of generating voice regardless of the determination criterion.

In addition, when a determination criterion is set for each user, the way of generating the voice of the automatic response AI is changed for each user. That is, the voice of the automatic response AI is output according to the way of generating voice according to the determination criterion associated with the user interacting with the automatic response AI. Thus, it becomes easier for the user to recognize whether the determination criterion of the automatic response AI interacting with the user is set for the user than a case where voice is output in a constant way of generating voice regardless of the user.

When the user A inputs the remark contents 44 to the terminal device 10 by voice, the changing unit 22 may apply a voice speech recognition process to identify who is the user A generating the voice. In this case, according to a result of the identification, the changing unit 22 changes the determination criterion of the automatic response AI to that associated with the user A and changes the way of generating the voice of the automatic response AI to a way of generating voice according to the determination criterion associated with the user A. For example, when the user A inputs the remark contents to the terminal device 10 by voice, the voice of the automatic response AI is output according to the way of generating voice according to the determination criterion associated with the user A. When the user B inputs the remark contents to the terminal device 10 by voice, the voice of the automatic response AI is output according to the way of generating voice according to the determination criterion associated with the user B. Regardless of the presence or absence of login to the terminal device 10, the changing unit 22 may identify the user's voice and execute the above process.

In the second exemplary embodiment, the changing unit 22 may change the way of generating the voice of the automatic response AI without changing the determination criterion for the response from the automatic response AI. As to the way of generating voice, for example, when at least one setting item is selected by the user from a setting item group including age range, occupation, personality, character and environment, the changing unit 22 changes the way of generating the voice of the automatic response AI to a way of generating voice according to the selected one or more setting items. The way of generating voice is the same as that illustrated in FIG. 7. At this time, the changing unit 22 changes the way of generating the voice of the automatic answering AI without performing the process according to the first exemplary embodiment (i.e., without changing the determination criterion itself for the response from the automatic response AI). Thus, the automatic response AI outputs voice according to the set way of generating voice. The automatic response AI responds according to a predetermined determination criterion.

### Third Exemplary Embodiment

Hereinafter, an information processing system according to a third exemplary embodiment will be described. In the third exemplary embodiment, as in the second exemplary embodiment, the automatic response AI responds by voice. FIG. 9 illustrates an example of the information processing system according to the third exemplary embodiment. The information processing system according to the third exemplary embodiment includes a repeater 58 as an example of an information processing apparatus, and a device 60, in addition to the configuration of the information processing system according to the first exemplary embodiment. For example, the terminal device 10, the server 12, the repeater 58 and the device 60 have a function of communicating with each other via the communication path N. In the third exemplary embodiment, a process by the changing unit 22 is executed by the repeater 58. The information processing system according to the third exemplary embodiment may not include the terminal device 10, the server 12 and the device 60. Plural devices 60 may be included in the information processing system.

The repeater 58 as an example of the information processing apparatus includes the above-described automatic response AI and has a function of interacting with a user by voice. Further, the repeater 58 may have a function of controlling one or more devices 60. For example, when a connected home (a system for connecting devices 60 such as home appliances and the like by a network using IoT technology) is constructed, the repeater 58 may be used as an apparatus for controlling the devices 60. In this case, the devices 60 are interconnected via the repeater 58. Of course, the devices 60 may be directly interconnected without the repeater 58 or may be interconnected via the server 12.

The device 60 is, for example, an image forming device having an image forming function (a scanning function, a printing function, a copying function, a facsimile function, etc.), a PC, a tablet PC, a smartphone, a mobile phone, a robot (a humanoid robot, an animal robot other than humanoid robots, or any other robot), a display device such as a projector and a liquid crystal display, a recording device, a reproducing device, an image capturing device such as a camera, a refrigerator, a rice cooker, a microwave oven, a coffee maker, a vacuum cleaner, a washing machine, an air conditioner, a lighting device, a clock, a surveillance camera, an automobile, a motorcycle, an aircraft (e.g., an unmanned aerial vehicle (so-called drone), a game machine, various sensing devices (e.g., a temperature sensor, a humidity sensor, a voltage sensor, a current sensor, etc.), etc. The device 60 may be a device that provides an output to a user (such as an image forming device or a PC), or may be a device that does not provide an output to a user (such as a sensing device). The category of the concept of the device 60 may include the general devices. For example, information equipment, video equipment, audio equipment and other equipment may be included in the category of the device according to the present exemplary embodiment. Further, the device 60 has a function of exchanging data with other devices.

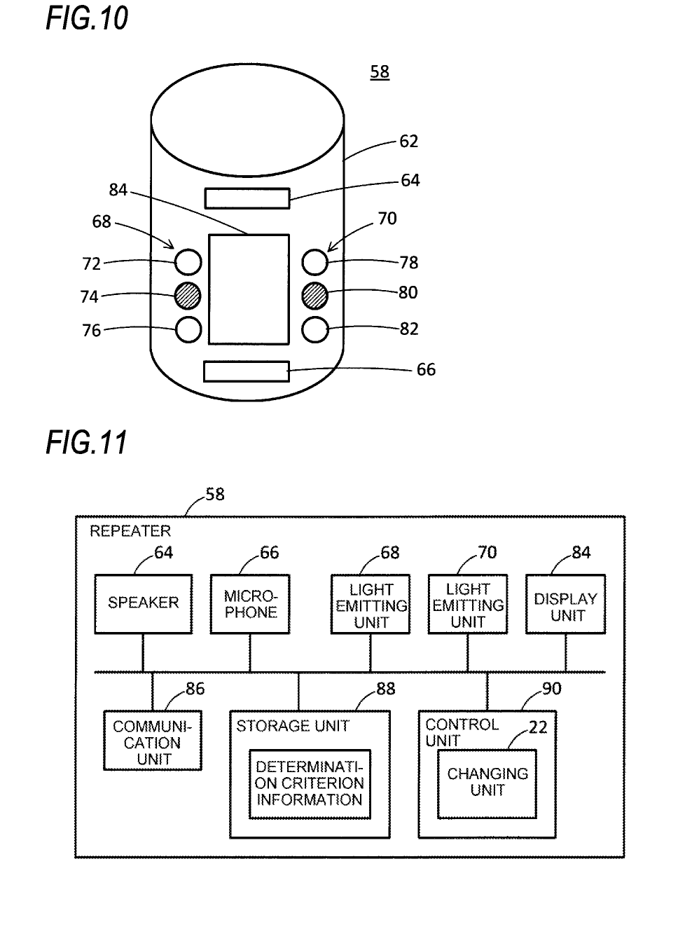

The external appearance of the repeater 58 will be described below with reference to FIG. 10. FIG. 10 is a perspective view illustrating the repeater 58. The repeater 58 is a so-called smart speaker and has a communication function and a voice assist function. The repeater 58 includes a columnar body portion 62. A speaker 64, a microphone 66, light emitting units 68 and 70 and a display unit 84 are provided on the side surface of the body portion 62. The shape of the body portion 62 is not limited to that illustrated in FIG. 10. The repeater 58 may be of any shape as long as it includes the speaker 64 and the microphone 66. In addition, the speaker 64, the microphone 66, the light emitting units 68 and 70 and the display unit 84 may be arranged at positions other than those illustrated in FIG. 10.

When a user is interacting with an automatic response AI, the remark contents of the automatic response AI are emitted by voice from the speaker 64. In addition, music, television sounds, radio sounds and the like may be emitted from the speaker 64.

The microphone 66 functions as a sound collecting device to collect sound around the repeater 58. For example, the voice of the user is collected by the microphone 66.

The light emitting unit 68 includes one or more light sources (e.g., light sources 72, 74 and 76) and emits light in a way according to the set automatic response AI (bot). That is, the light emitting unit 68 emits light in a way according to the set determination criterion. For example, when a doctor is set as an occupation setting item, the light sources 72 and 76 emit blue light and the light source 74 emits yellow light. When a different setting item is set, the light emitting unit 68 emits light in a way according to the set contents.

The light emitting unit 70 includes one or more light sources (e.g., light sources 78, 80 and 82) and emits light in a way according to the user account associated with the current determination criterion of the automatic response AI. For example, when the determination criterion associated with the user B is set as the determination criterion of the automatic response AI, the light sources 78 and 82 emit blue light and the light source 80 emits yellow light. When a determination criterion associated with another user is used, the light emitting unit 70 emits light in a way according to the user.

The light emitting units 68 and 70 may be provided in the body portion 62 without being distinguished. For example, all the light sources included in the light emitting units 68 and 70 may be used to express the set determination criterion (automatic response AI) or user account. In addition, a light emission pattern of each light source (e.g., way of blinking, time interval, etc.) may be used to express the set determination criterion or user account.

The display unit 84 is a display device. The display unit 84 may be a user interface also serving as an operation unit (e.g., a touch panel or the like).

Hereinafter, the configuration of the repeater 58 will be described in more detail with reference to FIG. 11. FIG. 11 illustrates an example of the configuration of the repeater 58.

The repeater 58 includes a communication unit 86, a storage unit 88 and a control unit 90 in addition to the above-described speaker 64, microphone 66, light emitting units 68 and 70 and display unit 84.

The communication unit 86 is a communication interface and has a function of transmitting data to other devices and a function of receiving data from other devices. The communication unit 86 may be a communication interface having a wireless communication function or a communication interface having a wired communication function. For example, the communication unit 86 corresponds to one or more types of communication methods and may communicate with a communication partner according to a communication method suitable for the communication partner. The communication methods are, for example, infrared communication, visible light communication, Wi-Fi communication, close proximity wireless communication, etc. Other communication methods may also be used. In addition, the communication unit 86 may switch the communication method or the frequency band depending on a communication partner or the surrounding environments.

The storage unit 88 is a storage device such as a hard disk drive or a memory (e.g., SSD, etc.). The storage unit 88 stores, for example, various data, various programs (e.g., OS, various application programs, etc.), information indicating addresses of other devices (e.g., the terminal device 10, the server 12, the device 60, etc.), and the like. They may be stored in separate storage devices or may be stored in one storage device.

In addition, an automatic response AI program for implementing the automatic response AI is stored in the storage unit 88 and is executed to implement the function of the automatic response AI. The automatic response AI program may be stored in an external device such as the server 12 and may be executed by the external device so that the function of the automatic response AI can be provided from the external device to the repeater 58. In this case, the automatic response AI program may not be stored in the storage unit 88.

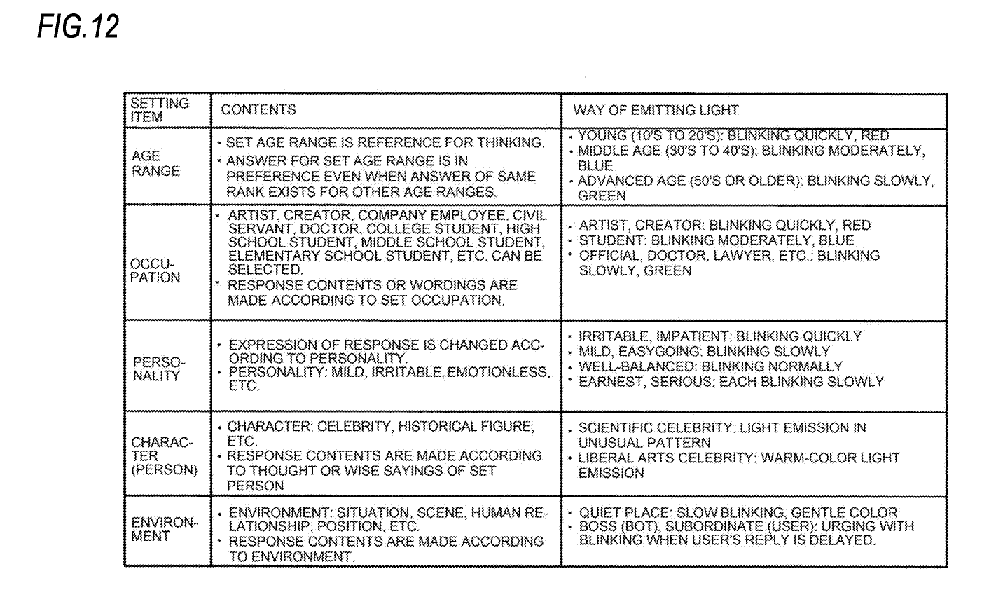

In addition, the storage unit 88 stores determination criterion information. For example, the information illustrated in FIG. 3 and FIG. 7 is stored in the storage unit 88. In addition, the information illustrated in FIG. 12 (to be described later) is stored in the storage unit 88.

The control unit 90 has a function of controlling the operation of each unit of the repeater 58. For example, the control unit 90 performs execution of various programs, control of output of sound by the speaker 64, control of sound collection by the microphone 66, control of light emission by the light emitting units 68 and 70, control of information display by the display unit 84, control of communication by the communication unit 86, and the like. In addition, when the control unit 90 executes the automatic response AI program, the function of the automatic response AI is implemented. Further, the control unit 90 includes a changing unit 22.

As in the second exemplary embodiment, the changing unit 22 changes the determination criterion (the contents of the setting items) for response from the automatic response AI and changes the way of generating the voice of the automatic response AI according to the changed determination criterion. For example, according to the information illustrated in FIG. 7, the changing unit 22 changes the way of generating the voice of the automatic response AI. Further, in the third exemplary embodiment, the changing unit 22 changes the way of emitting light from the light emitting unit 68 according to the set determination criterion. In addition, the changing unit 22 changes the way of emitting light from the light emitting unit 70 according to the user account associated with the set determination criterion. In addition, the changing unit 22 may apply a voice recognition process to the user's voice collected by the microphone 66 to identify the user and may change the way of emitting light from the light emitting unit 70 to a way of emitting light according to the user. In addition, the changing unit 22 may change the determination criterion of the automatic response AI to the determination criterion associated with the user identified by voice and may change the way of generating the voice of the automatic response AI to a way of generating voice according to the determination criterion associated with the user.

As described above, according to the information illustrated in FIG. 7, the changing unit 22 changes the way of generating the voice of the automatic response AI. The voice is output from the speaker 64. Hereinafter, the way of emitting light from the light emitting unit 68 for each setting item will be described with reference to FIG. 12. FIG. 12 illustrates the way of emitting light for each setting item. The information illustrated in FIG. 12 is stored in the storage unit 18 as determination criterion information. The integration of the information illustrated in FIG. 7 and the information illustrated in FIG. 12 may be stored in the storage unit 18.

When the age range is set, the changing unit 22 changes the way of emitting light from the light emitting unit 68 to a way of emitting light according to the set age range. Thus, the light emitting unit 68 emits light in a way according to the set age range. For example, when “young age (e.g., 10's to 20's)” is set as the age range, the changing unit 22 changes the way of emitting light from the light emitting unit 68 to a way of emitting light “blinking quickly and red”. In addition, when “middle age (e.g., 30's to 40's)” is set as the age range, the changing unit 22 changes the way of emitting light from the light emitting unit 68 to a way of emitting light “blinking moderately and blue”. When “advanced age (e.g., 50's or older)” is set as the age range, the changing unit 22 changes the way of emitting light from the light emitting unit 68 to a way of emitting light “blinking slowly and green”.

When the occupation is set, the changing unit 22 changes the way of emitting light from the light emitting unit 68 to a way of emitting light according to the set occupation. Thus, the light emitting unit 68 emits light in a way according to the set occupation. For example, when “artist or creator” is set as the occupation, the changing unit 22 changes the way of emitting light from the light emitting unit 68 to a way of emitting light “blinking quickly and red”. When “student” is set as the occupation, the changing unit 22 changes the way of emitting light from the light emitting unit 68 to a way of emitting light emitting “blinking moderately and blue”. When “official, doctor, lawyer, etc.” is set as the occupation, the changing unit 22 changes the way of emitting light from the light emitting unit 68 to way of emitting light “blinking slowly and green”.

When the personality is set, the changing unit 22 changes the way of emitting light from the light emitting unit 68 to a way of emitting light according to the set personality. Thus, the light emitting unit 68 emits light in a way according to the set personality. For example, when “irritable or impatient” is set as the personality, the changing unit 22 changes the way of emitting light from the light emitting unit 68 to a way of emitting light “blinking quickly”. When “mild or easygoing” is set as the personality, the changing unit 22 changes the way of emitting light from the light emitting unit 68 to a way of emitting light “blinking slowly”. When “well-balanced” is set as the personality, the changing unit 22 changes the way of emitting light from the light emitting unit 68 to a way of emitting light “blinking normally”. When “earnest or serious” is set as the personality, the changing unit 22 changes the way of emitting light from the light emitting unit 68 to a way of emitting light “blinking slowly at each time”.

When the character is set, the changing unit 22 changes the way of emitting light from the light emitting unit 68 to a way of emitting light according to the set character. Thus, the light emitting unit 68 emits light in a way according to the set character. For example, when “scientific celebrity” is set as the character, the changing unit 22 changes the way of emitting light from the light emitting unit 68 to a way of emitting light “in an unusual pattern”. Further, when “liberal arts celebrity” is set as the character, the changing unit 22 changes the way of emitting light from the light emitting unit 68 to a way of emitting light of “a warm color.”

When the environment is set, the changing unit 22 changes the way of emitting light from the light emitting unit 68 to a way of emitting light according to the set environment. Thus, the light emitting unit 68 emits light in a way according to the set environment. For example, when “quiet place” is set as the environment, the changing unit 22 changes the way of emitting light from the light emitting unit 68 to a way of emitting light “blinking slowly in a gentle color”. When “the bot is a boss and the user is a subordinate” is set as the environment, the changing unit 22 changes the way of emitting light from the light emitting unit 68 to a way of emitting light in such a manner that “urging with blinking occurs when the user's reply is delayed”.

A specific example of communication by voice will be described below. For example, when the automatic response AI installed in the repeater 58 outputs a remark content saying “May I help you?”, the remark content is output from the speaker 64 by voice. In the meantime, for example, when the user A provides the remark contents saying “Tell me recommended music” by voice, the voice is collected by the microphone 66. The changing unit 22 applies a voice recognition process to the voice to identify the speaker as the user A and changes the determination criterion of the automatic response AI to a determination criterion associated with the user A. For example, when the age range “1990's” is set as the determination criterion associated with the user A, the automatic response AI searches for songs hit in the 1990's. In addition, the changing unit 22 changes the way of generating the voice of the automatic response AI to a way of generating voice according to the determination criterion associated with the user A. As a result, the remark contents indicating the songs hit in the 1990's are emitted from the speaker 64 by voice according to the voice generating way according to the determination criterion associated with the user A. Further, the control unit 90 changes the way of emitting light from the light emitting unit 68 to a light emitting way according to the determination criterion associated with the user A and changes the way of emitting light from the light emitting unit 70 to a light emitting way associated with the user A (a light emitting way for identifying the user A). As a result, the light emitting unit 68 emits light according to the light emitting way according to the determination criterion associated with the user A and the light emitting unit 70 emits light according to the light emitting way associated with the user A.

The control unit 90 may display the remark contents on the display unit 84. For example, the remark contents 42, 44 and 46 illustrated in FIG. 5 and FIG. 8 are displayed on the display unit 84. For example, the remark contents of the automatic response AI are displayed on the display unit 84 and are emitted from the speaker 64 by voice.

According to the third exemplary embodiment, similarly to the second exemplary embodiment, when the automatic response AI outputs a response by voice, the voice is output according to a voice generating way according to a set determination criterion. In addition, the light emitting unit 68 emits light according to a light emitting way according to the determination criterion. Thus, the user may more easily visually recognize the set determination criterion than a case where the light emitting unit 68 emits light according to a certain light emitting way irrespective of a determination criterion. In addition, the light emitting unit 70 emits light according to a light emitting way according to a user. Thus, the user may more easily visually recognize whom the determination criterion is set for than when such a light emitting unit 70 is not used.

The above process may be executed by the terminal device 10 and the repeater 58. For example, while the remark contents of the automatic response AI are being displayed on the terminal device 10, information indicating the remark contents may be transmitted from the terminal device 10 to the repeater 58 and the remark contents may be emitted from the speaker 64 by voice. In addition, the user's voice may be collected by the microphone 66 of the repeater 58 and information indicating the voice may be transmitted from the repeater 58 to the terminal device 10 and displayed on the terminal device 10 as the user's remark contents. In this case, the automatic response AI and the changing unit 22 may be installed in the terminal device 10 and not installed in the repeater 58.

In the third exemplary embodiment, the changing unit 22 may change the way of emitting light from the light emitting unit 68 according to the determination criterion of the automatic response AI without changing the way of generating the voice of the automatic response AI. In this case, the automatic response AI outputs a voice according to a predetermined voice generating way.

Further, in the third exemplary embodiment, the changing unit 22 may change the way of generating the voice of the automatic response AI or the way of emitting light from the light emitting unit 68 without changing the determination criterion for response from the automatic response AI. For example, as the way of emitting light from the light emitting unit 68, when at least one setting item is selected by the user from a setting item group including age range, occupation, personality, character and environment, the changing unit 22 changes the way of generating the voice of the automatic response AI to a way of generating voice according to the selected one or more setting items and changes the way of emitting light from the light emitting unit 68 to a way of emitting light according to the selected one or more setting items. The voice generating way is the same as that illustrated in FIG. 7 and the way of emitting light from the light emitting unit 68 is the same as that illustrated in FIG. 12. At this time, the changing unit 22 changes the way of generating the voice of the automatic response AI and the way of emitting light from the light emitting unit 68 without performing the process according to the first exemplary embodiment (i.e., without changing the determination criterion itself for response from the automatic response AI). Thus, the automatic response AI outputs a voice according to the set voice generating way and the light emitting unit 68 emits light according to the set light emitting way. The automatic response AI responds according to a predetermined determination criterion.

### Fourth Exemplary Embodiment

A fourth exemplary embodiment will be described below. In the above-described first to third exemplary embodiments, the changing unit 22 may change the image associated with the automatic response AI according to the set determination criterion. In the first and second exemplary embodiments, the image associated with the automatic response AI is displayed on the screen 36 of the terminal device 10 and is changed according to the set determination criterion. In the third exemplary embodiment, the image associated with the automatic response AI is displayed on the display unit 84 of the repeater 58 and is changed according to the set determination criterion.

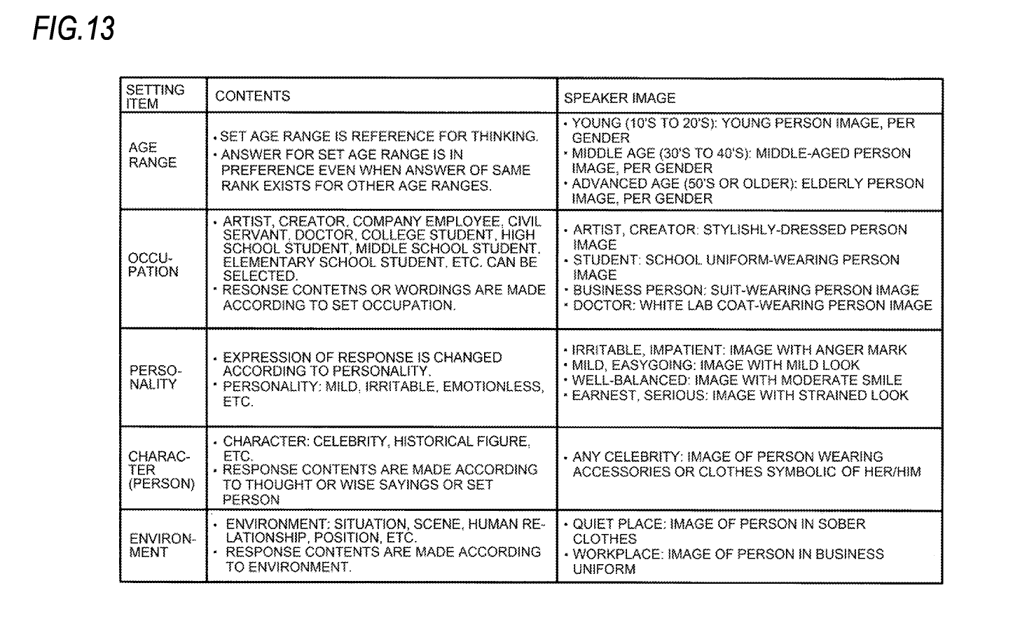

FIG. 13 illustrates a speaker image for each setting item. The information illustrated in FIG. 13 is stored as the determination criterion information in the storage unit 18 of the terminal device 10 according to the first and second exemplary embodiments or is stored as the determination criterion information in the storage unit 88 of the repeater 58 according to the third exemplary embodiment.

When the age range is set, the changing unit 22 changes the image associated with the automatic response AI to an image according to the set age range. For example, when “young age (e.g., 10's to 20's)” is set as the age range, the changing unit 22 changes the image associated with the automatic response AI to a “young person image”. When “middle age (e.g., 30's to 40's)” is set as the age range, the changing unit 22 changes the image associated with the automatic response AI to a “middle-aged person image”. When “advanced age (e.g., 50's or older)” is set as the age range, the changing unit 22 changes the image associated with the automatic response AI to an “elderly person image”. When the gender of the automatic response AI is set, the changing unit 22 changes the image associated with the automatic response AI to an image representing the gender. When the gender is not set, the changing unit 22 reflects only a change according to the age in the image.

When the occupation is set, the changing unit 22 changes the image associated with the automatic response AI to an image according to the set occupation. For example, when “artist or creator” is set as the occupation, the changing unit 22 changes the image associated with the automatic response AI to a “stylishly-dressed person image”. When “student” is set as the occupation, the changing unit 22 changes the image associated with the automatic response AI to a “school uniform-wearing person image”. When “business person” is set as the occupation, the changing unit 22 changes the image associated with the automatic response AI to a “suit-wearing person image”. When “doctor” is set as the occupation, the changing unit 22 changes the image associated with the automatic response AI to a “white lab coat-wearing person image”.

When the personality is set, the changing unit 22 changes the image associated with the automatic response AI to an image according to the set personality. For example, when “irritable or impatient” is set as the personality, the changing unit 22 changes the image associated with the automatic response AI to an “image with an anger mark”. When “mild or easygoing” is set as the personality, the changing unit 22 changes the image associated with the automatic response AI to an “image with a mild look”. When “well-balanced” is set as the personality, the changing unit 22 changes the image associated with the automatic response AI to an “image with a moderate smile”. When “earnest or serious” is set as the personality, the changing unit 22 changes the image associated with the automatic response AI to an “image with a strained look”.

When the character is set, the changing unit 22 changes the image associated with the automatic response AI to an image according to the set character. For example, the changing unit 22 changes the image associated with the automatic response AI to an “image of a person wearing accessories or clothes symbolic of her or him (the celebrity)”.

When the environment is set, the changing unit 22 changes the image associated with the automatic response AI to an image according to the set environment. For example, when “quiet place” is set as the environment, the changing unit 22 changes the image associated with the automatic response AI to an “image of a person in sober clothes”. When “workplace” is set as the environment, the changing unit 22 changes the image associated with the automatic response AI to an “image of a person in business uniform”.

When the user's age range, occupation, personality, character, environment, etc. are set, the changing unit 22 may change the image associated with the user to an image according to the set contents.

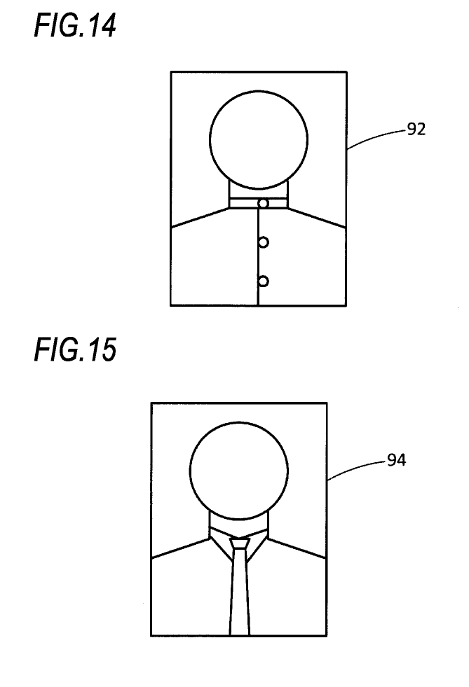

FIGS. 14 and 15 illustrate examples of the image associated with the automatic response AI. For example, when “student” is set as the occupation, as illustrated in FIG. 14, an image 92 representing a person wearing a school uniform is displayed as the image associated with the automatic response AI. When “business person” is set as the occupation, as illustrated in FIG. 15, an image 94 representing a person wearing a dress shirt and a tie or an image of a person wearing a suit is displayed as the image associated with the automatic response AI. As described above, when the occupation of the user is a student, the image 92 displayed may be an image associated with the user. When the occupation of the user is a business person, the image 94 displayed may be an image associated with the user.

According to the fourth exemplary embodiment, the image associated with the automatic response AI is changed according to the determination criterion. Thus, the user may more easily visually recognize the set determination criterion than a case where a certain image is displayed as an image associated with the automatic response AI irrespective of the determination criterion.

Each of the terminal device 10, the server 12 and the repeater 58 is implemented by cooperation of hardware and software as an example. Specifically, each of the terminal device 10, the server 12 and the repeater 58 includes one or more processors such as a CPU (not illustrated). The one or more processors read out and execute a program stored in a storage device (not illustrated) to implement the function of each of units of the terminal device 10, the server 12 and the repeater 58. The program is stored in the storage device via a recording medium such as a CD or a DVD or via a communication path such as a network. As another example, the respective units of the terminal device 10, the server 12 and the repeater 58 may be implemented by hardware resources such as a processor, an electronic circuit, an ASIC (Application Specific Integrated Circuit) and the like. A device such as a memory may be used for the implementation. As still another example, the respective units of the terminal device 10, the server 12 and the repeater 58 may be implemented by a DSP (Digital Signal Processor), a FPGA (Field Programmable Gate Array) or the like.

The foregoing description of the exemplary embodiments of the present invention has been provided for the purposes of illustration and description. The above exemplary embodiments are not intended to limit the invention. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a changing unit that changes a determination criterion for a response from a response assistant that responds to an inquiry of a user.

2. The information processing apparatus according to claim 1, wherein
the determination criterion includes a plurality of setting items, and the changing unit changes contents of the setting items each individually.

3. The information processing apparatus according to claim 2, wherein
the changing unit changes the contents of the setting item after the response assistant starts to operate.

4. The information processing apparatus according to claim 3, wherein
the changing unit changes the contents of the setting item based on a communication between the user and the response assistant.

5. The information processing apparatus according to claim 2, wherein
the response assistant notifies the user of detailed information based on the changed contents of the setting item in the response to the inquiry of the user.

6. The information processing apparatus according to claim 2, wherein
the response assistant preferentially notifies the user of information based on the changed contents of the setting item in the response to the inquiry of the user.

7. The information processing apparatus according to claim 2, wherein
the response assistant responds to the inquiry of the user within a range covering the changed contents of the setting item.

8. The information processing apparatus according to claim 2, wherein
the plurality of setting items are selected from a setting item group including age range, occupation, personality, character and environment, and
the response assistant responds according to a criterion set using the plurality of setting items.

9. The information processing apparatus according to claim 2, wherein
the setting item is age range, and
the response assistant notifies the user of the response based on a set age range.

10. The information processing apparatus according to claim 2, wherein
the setting item is occupation, and
the response assistant notifies the user of the response based on a set occupation.

11. The information processing apparatus according to claim 2, wherein
the setting item is personality, and
the response assistant notifies the user of the response based on a set personality.

12. The information processing apparatus according to claim 2, wherein
the setting item is character, and
the response assistant notifies the user of the response based on a set character.

13. The information processing apparatus according to claim 2, wherein
the setting item is environment, and
the response assistant notifies the user of the response based on a set environment.

14. The information processing apparatus according to claim 1, wherein
the changing unit further changes a way of generating voice of the response assistant
according to the determination criterion.

15. The information processing apparatus according to claim 14, wherein
the changing unit changes the way of generating voice of the response assistant to a way of generating voice according to at least one setting item from a setting item group including age range, occupation, personality, character and environment.

16. The information processing apparatus according to claim 14, wherein
the voice of the response assistant is output from a repeater that controls a device.

17. The information processing apparatus according to claim 1, wherein
the changing unit changes, according to the determination criterion, a way of emitting light from a light emitting unit that emits light according to the response.

18. The information processing apparatus according to claim 17, wherein
the changing unit changes the way of emitting light to a way of emitting light according to at least one setting item from a setting item group including age range, occupation, personality, character and environment.

19. The information processing apparatus according to claim 17, wherein
the light emitting unit is provided in a repeater that controls a device.

20. The information processing apparatus according to claim 1, wherein
the changing unit further changes an image associated with the response assistant according to the determination criterion.

21. The information processing apparatus according to claim 20, wherein
the changing unit changes the image to an image according to at least one setting item from a setting item group including age range, occupation, personality, character and environment.

22. The information processing apparatus according to claim 20, wherein
the image is displayed on a repeater that controls a device.

23. The information processing apparatus according to claim 1, wherein
the changing unit performs the change for each user.

24. A non-transitory computer readable medium storing a program causing a computer to execute information processing, the information processing comprising:
changing a determination criterion for a response from a response assistant that responds to an inquiry of a user.
